(19) United States
(12) Patent Application Publication
(10) Pub. No.: US 2009/0003370 A1
(43) Pub. Date: Jan. 1, 2009

(54) SYSTEM AND METHOD FOR IMPROVED PERFORMANCE BY A DVB-H RECEIVER

(75) Inventors: Sushil Kering, Irvine, CA (US); Neeraj Kashalkar, Irvine, CA (US); Stephen A. Mueller, Foothill Ranch, CA (US)

Correspondence Address: FIALA & WEAVER, P.L.L.C.;C/O INTELLEVATE, P.O. BOX 52050, MINNEAPOLLS, MN, 55402, US

(73) Assignee: BROADCOM CORPORATION, Irvine, CA (US)

(21) Appl. No.: 11/847,839

(22) Filed: Aug. 30, 2007

Related U.S. Application Data
(60) Provisional application No. 60/946,269, filed on Jun. 26, 2007.

(51) Int. Cl. H04L 12/56

(52) U.S. Cl. 370/412

(57) ABSTRACT

A system and method for improved performance by a DVB-H receiver is described that allows good Internet Protocol (IP) packets in a Multiprotocol Encapsulation-Forward Error Correction (MPE-FEC) frame to be salvaged even when there are other IP packets in the frame that may have bytes in error after the performance of MPE-FEC operations. To achieve this, the system and method provides a means for ascertaining where IP packets loaded into a memory begin and end in a manner that can be relied upon even when individual bytes of the IP packets, such as certain bytes of the IP packet header used to determine total packet length, may be in error.

### CROSS-REFERENCE TO RELATED APPLICATIONS

This application claims priority to Provisional U.S. Patent Application No. 60/946,269, entitled “Improved MPE-FEC Performance in a DVB-H Receiver,” filed Jun. 26, 2007, the entirety of which is incorporated by reference herein.

### BACKGROUND OF THE INVENTION

1. Field of the Invention

The invention generally relates to systems and methods that increase the amount of data recovered after the performance of error correction operations in a receiver, such as in a Digital Video Broadcast-Handheld (DVB-H) receiver that performs error correction operations in accordance with a Multiprotocol Encapsulation-Forward Error Correction (MPE-FEC) technique.

2. Background

Conventional Digital Video Broadcast-Handheld (DVB-H) receivers perform error correction operations in accordance with a Multiprotocol Encapsulation-Forward Error Correction (MPE-FEC) technique. In accordance with this technique, the receiver loads Internet Protocol (IP) packets and associated parity data corresponding to an MPE-FEC frame into a table. The IP packets and associated parity data are loaded into the table as a series of byte-wide columnar segments. So loaded, the rows of the table are then treated as Reed Solomon (RS) codewords for the purpose of performing error correction operations. Erasure information associated with each byte in the MPE-FEC frame is also stored and is used to improve the performance of the RS decoding. The erasure information indicates whether a byte may contain an error and may be derived from FEC previously applied to a Transport Stream (TS) packet or a cyclic redundancy check (CRC) previously applied to an MPE section.

FIG. 1 depicts the structure 100 of an MPE-FEC frame. Each MPE-FEC frame consists of 255 columns and a maximum of 1024 rows. Each cell within the frame corresponds to a single byte and the maximum frame size is approximately 2 Mbits. As shown in FIG. 1, the frame is separated into two adjacent tables: an application data table 102 and an RS data table 104.

During decoding, the 191 columns of application data table 102 are populated with IP packets (and optional padding bytes) while the 64 columns of RS data table 104 are respectively populated with 64 associated RS parity byte segments. The IP packets and RS parity byte data are loaded from left to right in a column-by-column fashion. To demonstrate this, FIG. 1 depicts an example IP packet 112 that has been loaded into application data table 102 as two byte-wide columnar segments 112a and 112b. FIG. 1 further depicts an example RS parity byte segment 114 that has been loaded into RS data table 104 as a single byte-wide columnar segment.

Once application data table 102 and RS data table 104 have been populated, RS decoding is performed on the data stored therein in a row-by-row fashion, wherein each row represents a RS codeword. To help illustrate this, FIG. 1 depicts a single RS codeword 116 that spans application data table 102 and RS data table 104. The RS decoding is performed in accordance with an RS (255,191) code. The RS decoding is used to correct a limited number of errors in each of the RS codewords. As noted above, stored erasure information associated with each byte in the MPE-FEC frame is used to improve the performance of the RS decoding.

After the RS decoding is complete, the IP packets stored in application data table 102 are read back out of the table in a column-by-column fashion for downstream processing and subsequent transmission to an application. However, if there were more errors in a given RS codeword then could be corrected by the RS decoding, then one or more IP packets read from the table may have bytes that are in error even after the RS decoding has completed.

Because of the high bit rates that DVB-H must support, it may be desired to implement the MPE-FEC decoder in hardware. In some hardware-based implementations, the table that stores the MPE-FEC frame may be implemented as a semiconductor memory, such as a static random access memory (SRAM). In such implementations, after RS decoding has finished, some technique must be used to ascertain where each IP packet loaded in the memory begins and ends so that the IP packets can be drained from the memory.

One approach to ascertaining where each IP packet loaded in the memory begins and ends is to rely on certain bytes located in the header of each IP packet to determine a total packet length. By knowing how big an IP packet is, it is possible to determine where the next IP packet in the memory starts. However, as noted above, it is possible that one or more bytes in each IP packet may be in error even after RS decoding has completed. If any of the bytes that are used to determine the total packet length is truly in error, then logic relying solely on those bytes to drain the IP packets from the memory will produce invalid IP packets starting with the IP packet having the erroneous byte(s) all the way through to the last IP packet in the MPE-FEC frame. One way of dealing with this possibility is to discard any MPE-FEC frame having one or more bytes that may be in error after RS decoding. However, discarding an entire MPE-FEC frame can have a noticeably adverse affect upon the quality of the audio and video content played back from the DVB-H receiver.

What is needed, then, is a system and method for providing improved performance by a DVB-H receiver. In particular, the desired system and method should provide a means for salvaging good IP packets in an MPE-FEC frame even when there are other IP packets in the frame that may have bytes in error after the performance of RS decoding. To this end, the desired system and method should provide a means for ascertaining where IP packets loaded into a memory begin and end in a manner that can be relied upon even when individual bytes of the IP packets, such as certain bytes of the IP packet header used to determine total packet length, may be in error.

### BRIEF SUMMARY OF THE INVENTION

A system and method is described for providing improved performance in a DVB-H receiver that performs error correction operations in accordance with a Multiprotocol Encapsulation-Forward Error Correction (MPE-FEC) technique. In one implementation, the system and method salvages good IP packets in an MPE-FEC frame even when there are other IP packets in the frame that may be have bytes in error after the performance of RS decoding. The system and method may achieve this by ascertaining where IP packets loaded into a memory begin and end in a manner that can be relied upon even when individual bytes of the IP packets, such as certain bytes of the IP packet header used to determine total packet length, may be in error.

In particular, a method is described for recovering Internet Protocol (IP) packets from an MPE-FEC frame stored in a memory after the performance of MPE-FEC operations, wherein the MPE-FEC frame includes a series of IP packets. In accordance with the method, a length of a first IP packet stored in the memory is determined based on information stored in the first IP packet. The MPE-FEC frame is then parsed to locate a second IP packet based on the determined length. A determination is then made as to whether the second IP packet is a valid IP packet. Responsive to a determination that the second IP packet is a valid IP packet, at least one of the first IP packet or an IP packet following the first IP packet in the series of IP packets is retained for further processing. The IP packet is retained regardless of whether the first IP packet includes a byte that may contain an error after the performance of the MPE-FEC operations. The method may further include discarding the first IP packet and any IP packets following the first IP packet in the series of IP packets responsive to determining that the second IP packet is not a valid IP packet.

A system is also described for recovering IP packets from an MPE-FEC frame after the performance of MPE-FEC operations, wherein the MPE-FEC frame includes a series of IP packets. The system includes a memory and an IP filter. The memory is configured to store the series of IP packets. The IP filter is configured to determine the length of a first IP packet stored in the memory based on information stored in the first IP packet. The IP filter is further configured to parse the MPE-FEC frame to locate a second IP packet based on the determined length. The IP filter is still further configured to determine if the second IP packet is a valid IP packet, and to retain at least one of the first IP packet or an IP packet following the first IP packet in the series of IP packets responsive to determining that the second IP packet is a valid IP packet. The IP packet is retained regardless of whether the first IP packet includes a byte that may contain an error after the performance of MPE-FEC operations. The IP filter may be further configured to discard the first IP packet and any IP packets following the first IP packet in the series of IP packets responsive to determining that the second IP packet is not a valid IP packet.

An additional method is also described for recovering IP packets from an MPE-FEC frame stored in a memory after the performance of MPE-FEC operations, wherein the MPE-FEC frame includes a series of IP packets. In accordance with the additional method, information is stored that indicates where each IP packet in the series of IP packets is stored in the memory. MPE-FEC operations are then performed on the series of IP packets stored in the memory. Each IP packet in the series of IP packets is then read from the memory using the stored information to determine where each IP packet begins and ends. At least one IP packet in the series of IP packets is retained for further processing regardless of whether another IP packet in the series of IP packets includes a byte that may contain an error after the performance of the MPE-FEC operations.

An alternative system is also described for recovering IP packets from an MPE-FEC frame after the performance of MPE-FEC operations, wherein the MPE-FEC frame includes a series of IP packets. The system includes a memory, control logic, error correction logic, and an IP filter. The memory is configured to store the series of IP packets. The control logic is coupled to the memory and is configured to store information indicating where each IP packet in the series of IP packets is stored in the memory. The error correction logic is configured to perform MPE-FEC operations on the series of IP packets stored in the memory. The IP filter is coupled to the memory and is configured to read each IP packet in the series of IP packets from the memory using the stored information to determine where each IP packet begins and ends. The IP filter is also configured to retain at least one IP packet in the series of IP packets for further processing regardless of whether another IP packet in the series of IP packets includes a byte that may contain an error after the performance of the MPE-FEC operations.

Further features and advantages of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate the present invention and, together with the description, further serve to explain the principles of the invention and to enable a person skilled in the relevant art(s) to make and use the invention.

FIG. 1 depicts the structure of a Multiprotocol Encapsulation-Forward Error Correction (MPE-FEC) frame.

FIG. 2 is a block diagram of an example Digital Video Broadcast-Handheld (DVB-H) receiver in which an embodiment of the present invention may be implemented.

FIG. 3 is a block diagram of an MPE-FEC decoder in accordance with an embodiment of the present invention.

FIG. 4 illustrates a flowchart of a method for draining IP packets from a memory in an MPE-FEC decoder in accordance with an embodiment of the present invention.

FIG. 5 is a block diagram of an MPE-FEC decoder in accordance with an alternate embodiment of the present invention.

FIG. 6 illustrates a flowchart of a method for writing IP packets into a memory and reading the IP packets therefrom in an MPE-FEC decoder in accordance with an embodiment of the present invention.

FIG. 7 illustrates a flowchart of a method for draining IP packets from a memory in an MPE-FEC decoder in accordance with an alternate embodiment of the present invention.

FIG. 8 illustrates a flowchart of one method for performing a step of the flowchart of FIG. 7 in accordance with an embodiment of the present invention.

The features and advantages of the present invention will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION OF THE INVENTION

### A. EXAMPLE OPERATING ENVIRONMENT

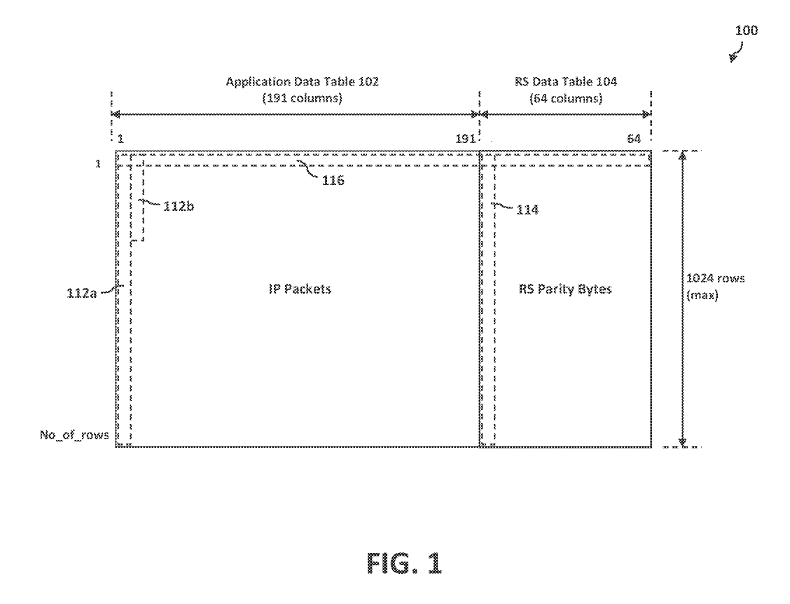

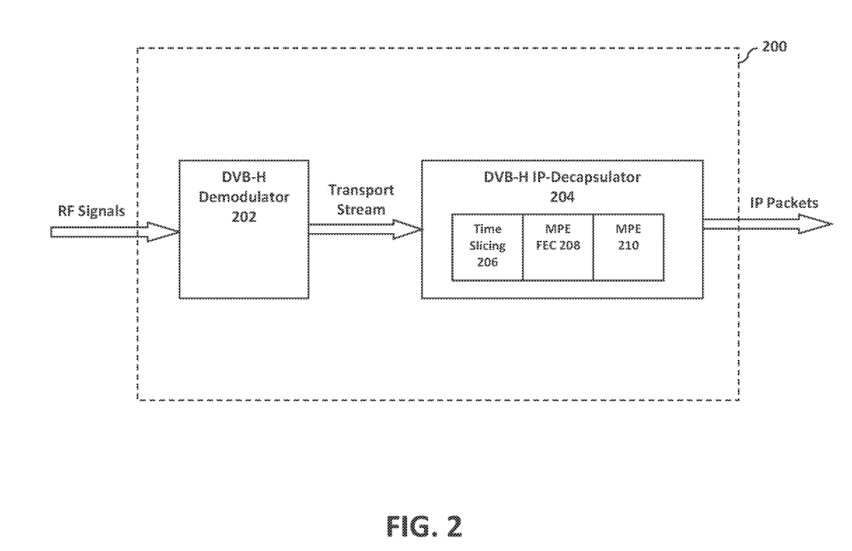

FIG. 2 is a block diagram of an example DVB-H (Digital Video Broadcast-Handheld) receiver 200 in which an embodiment of the present invention may be implemented. As shown in FIG. 2, DVB-H receiver 200 includes a DVB-H demodulator 202 and a DVB-H IP-decapsulator 204. DVB-H demodulator 202 is configured to receive RF signals carrying DVB-H video or audio/video (A/V) content and to demodulate those signals to produce an MPEG-2 transport stream. The RF signals may be received via an antenna and tuner (not shown in FIG. 1), each of which may be external with respect to receiver 200 or may be an integrated part of receiver 200.

DVB-H IP-decapsulator 204 is configured to receive the MPEG-2 transport stream from DVB-H demodulator 202 and to extract Internet Protocol (IP) packets therefrom. To perform these functions, DVB-H IP-decapsulator 204 includes time slicing logic 206, MPE-FEC logic 208, and MPE logic 210. The functions performed by these blocks are specified by the DVB-H standard (ETSI standard EN 302 304), the entirety of which is incorporated by reference herein. Because the functions performed by time slicing logic 206 and MPE logic 210 are not directly relevant to the present invention, these blocks will not be described herein for the sake of brevity. The general functions performed by MPE-FEC logic 208 have been described in the Background section above and various implementations of MPE-FEC logic 208 in accordance with embodiments of the present invention will be described in more detail below.

It should be noted that DVB-H receiver 200 has been described herein by way of example only and is not intended to limit the present invention. Persons skilled in the relevant art(s) will readily appreciate that the present invention may be implemented in operating environments other than DVB-H receiver 200.

### B. MPE-FEC DECODER IN ACCORDANCE WITH A FIRST EMBODIMENT OF THE PRESENT INVENTION

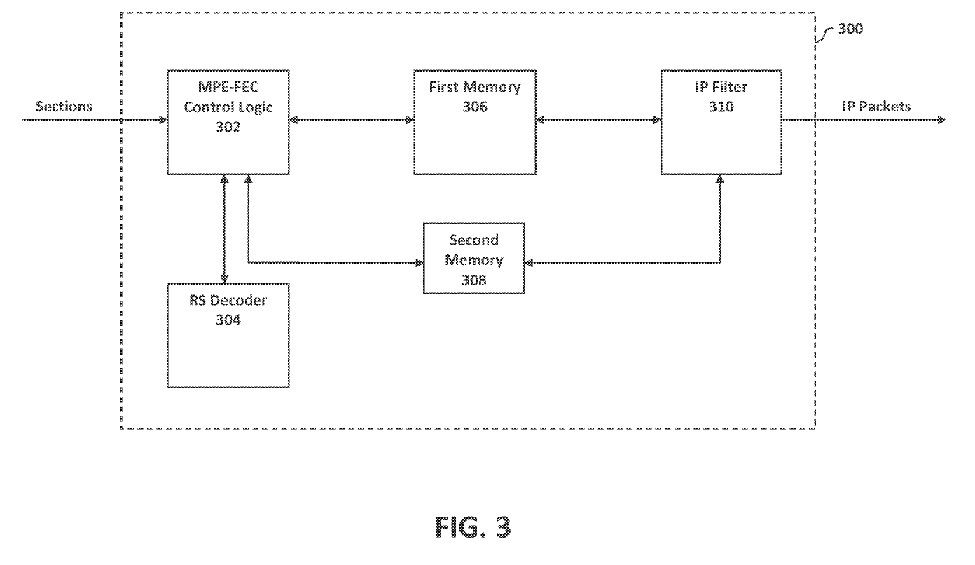

FIG. 3 is a block diagram of an MPE-FEC decoder 300 in accordance with an embodiment of the present invention. MPE-FEC decoder 300 may be used, for example, to implement all or part of MPE-FEC logic 208 of example DVB-H receiver 200 described above in reference to FIG. 2, although this example is not intended to limit the present invention. As will be appreciated by persons skilled in the relevant art(s), MPE-FEC decoder 300 may be used in other systems and operating environments.

Because of the high bit rates that DVB-H must support, MPE-FEC decoder 300 is implemented in hardware (in other words, as a combination of digital and/or analog circuits), although operating parameters associated with the functions of MPE-FEC decoder 300 may be configurable via software. As shown in FIG. 3, MPE-FEC decoder 300 includes MPE-FEC control logic 302, a Reed Solomon (RS) decoder 304, a first memory 306, a second memory 308, and an IP filter 310. Each of these elements will now be described.

MPE-FEC control logic 302 is configured to receive MPE sections and to extract IP packets and associated parity data therefrom. MPE-FEC control logic 302 is further configured to load the IP packets and associated parity data, which are part of a single MPE-FEC frame, into a first memory 306.

Each MPE-FEC frame consists of 255 columns and either 256, 512, 768 or 1024 rows, with each cell within the frame corresponding to a single byte. In one embodiment, first memory 306 comprises an array of memory cells of sufficient dimensions to accommodate an MPE-FEC frame of the largest possible size. In an alternate embodiment, first memory 306 comprises a plurality of memory cell arrays, wherein the number of memory cell arrays used to store a particular MPE-FEC frame depends on the size of the MPE-FEC frame. Thus, for example, first memory 306 may comprise four separate arrays of memory cells, each of which is capable of storing 256 rows of an MPE-FEC frame. First memory 306 may be implemented using any of a variety of well-known semiconductor memory types. For example, first memory 306 may be implemented using one or more static random access memories (SRAMs).

In an embodiment, the IP packets and associated parity data are loaded into first memory 306 as a series of byte-wide columnar segments. For example, a first 191 columns of first memory 306 may be populated with IP packets (and optional padding bytes) and a remaining 64 columns of first memory 306 may be loaded with 64 associated parity bytes segments. The IP packets and RS parity byte segments may be loaded into the memory array from left to right in a column-by-column fashion. So loaded, the rows of the memory array are then treated as RS codewords for the purpose of performing error correction operations. Persons skilled in the relevant art(s) will readily appreciate that the IP packets and associated parity data may just as easily be loaded into first memory 306 in a row-wise fashion, with the columns of the memory array being treated as RS codewords. However, for the purposes of simplifying the present description, it will be assumed that MPE-FEC control logic 302 loads IP packets and associated parity data into first memory 306 as a series of byte-wide columnar segments.

MPE-FEC control logic 302 calculates a physical address at which the first byte of a given IP packet should be written into first memory 306 based on information provided within the header of the MPE section that carries the IP packet as its payload. In particular, the physical address is calculated based on an 18-bit field carried in the MPE section header that specifies a logical address within an MPE-FEC table at which the first byte of the IP packet should be written. MPE-FEC control logic 302 converts this 18-bit logical address into a physical address within first memory 306.

MPE-FEC control logic 302 also receives erasure information associated with each byte of the IP packets and associated parity information stored in first memory 306 and stores such erasure information in a second memory 308. The erasure information indicates whether a byte may contain an error and may be derived from FEC previously applied to a Transport Stream (TS) packet or a cyclic redundancy check (CRC) previously applied to an MPE section. In one embodiment, the erasure information comprises a single erasure bit, wherein a first value of the erasure bit indicates that an associated byte may contain an error while a second value of the erasure bit indicates that an associated byte does not contain an error. The mapping between bytes stored in first memory 306 and corresponding erasure bits stored in second memory 308 is managed by MPE-FEC control logic 302. Like first memory 306, second memory 308 may be implemented using any of a variety of well-known semiconductor memory types. For example, first memory 306 may be implemented using one or more SRAMs.

Once first memory 306 has been loaded with IP packets and associated parity information in the manner set forth above and second memory 308 has been loaded with corresponding erasure information, MPE-FEC control logic 302 then reads out rows of information from first memory 306 for processing by RS decoder 304, wherein each row represents an RS codeword. RS decoding is performed in accordance with an RS (255, 191) code. RS decoder 304 decodes each RS codeword to correct a limited number of errors in each. MPE-FEC control logic 302 is further configured to read out erasure information associated with the bytes of each RS codeword from second memory 308 and provide the erasure information to RS decoder 304. As noted above, this erasure information may comprise erasure bits that indicate whether a corresponding byte in an RS codeword may contain an error. RS decoder 304 uses this erasure information to improve the performance of the RS decoding.

During the RS decoding process, a byte that was previously designated as possibly containing an error may be corrected such that it no longer may contain an error. In this instance, MPE-FEC control logic 302 modifies the erasure information associated with the byte to reflect the correction. Thus, for example, if the erasure information comprises an erasure bit, MPE-FEC control logic 302 alters the state of the bit to indicate that the byte does not contain an error. However, if there are more errors in a given RS codeword then can be corrected by RS decoder 304, then RS decoder 304 will be unable to correct any of the errors in that RS codeword. In this case, there will be bytes that may still contain errors in the RS codeword even after RS decoding has completed. The erasure information associated with these bytes will not change.

After the RS decoding has completed, the series of IP packets stored in first memory 306 must be read back out of first memory 306 in a column-by-column fashion for further downstream processing and subsequent transmission to an application. In MPE-FEC decoder 300, this function of reading the IP packets from first memory 306 is performed by IP filter 310. In order to perform this function, IP filter 310 must be able to determine the physical address at which each IP packet begins and ends within first memory 306. As will be described in more detail below, IP filter 310 is configured to perform this operation by relying on certain bytes located in the header of each IP packet to determine a total packet length. Because the IP packets are stored in series, by knowing how big an IP packet is, IP filter 310 can determine where in first memory 306 a next IP packet starts.

However, as noted above, it is possible that one or more bytes in each IP packet may be in error even after RS decoding has completed. If any of the bytes that are used to determine the total packet length is truly in error, then logic that relies solely on those bytes to drain the IP packets from first memory 306 will produce invalid IP packets starting with the IP packet having the erroneous byte(s) all the way through to the last IP packet in the MPE-FEC frame. One way of dealing with this possibility is to discard any MPE-FEC frame having one or more bytes that may be in error after RS decoding. However, discarding an entire MPE-FEC frame can have a noticeably adverse affect upon the quality of the audio and video content played back from the DVB-H receiver.

As will be described in more detail below, IP filter 310 addresses the foregoing issue by locating a length field in the header of each IP packet stored in first memory 306 that can be used to determine a total packet length. IP filter 310 then consults associated erasure information stored in second memory 308 to determine if any of the bytes of the length field bytes may still be in error after RS decoding has completed. If the erasure information indicates that none of these bytes may contain errors, then the IP packet may be retained (or optionally discarded if it contains other bytes that may be in error) and the length field is then used to calculate a total packet length from which the location of the next IP packet in first memory 306 may be determined.

However, if the erasure information indicates that at least one of the bytes of the length field may contain an error, then IP filter 310 performs a second test to determine if the length field is correct rather than immediately discarding the IP packet and all subsequent packets in the IP frame. This second test involves determining a total packet length based on the length field, using the determined total packet length to identify a location within first memory 306 at which a next IP packet should start, and then determining whether the next IP packet appears to be a valid IP packet. If the next IP packet does not appear to be valid, then IP filter 310 discards the current IP packet and all packets that follow it up to the end of the MPE-FEC frame. If the next IP packet does appear to be valid, then the current IP packet may be retained or discarded and the processing of the MPE-FEC frame may continue starting with the next IP packet. Thus, even in an instance where an IP packet includes bytes that are in error after RS decoding, an embodiment of the present invention allows good IP packets that follow the IP packet with errors to be preserved, so long as the bytes that are in error are not in the length field of the IP packet header.

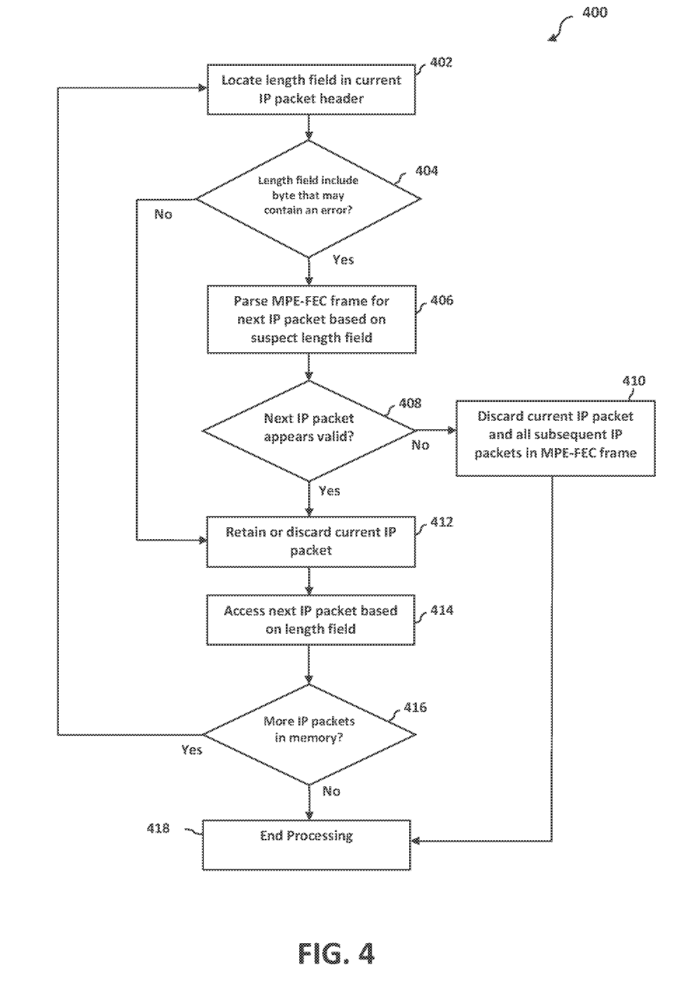

The manner in which IP filter 310 operates to read IP packets out of first memory 306 will now be described in more detail in reference to flowchart 400 of FIG. 4. The method of flowchart 400 will be described with continued reference to the components of MPE-FEC decoder 300 as described above in reference to FIG. 3. However, the method is not limited to that embodiment and persons skilled in the relevant art(s) will readily appreciate that the method of flowchart 300 may be performed by using other components or systems.

As shown in FIG. 4, the method of flowchart 400 begins at step 402, in which IP filter 310 locates a length field in the header of an IP packet that is currently being drained from first memory 306 (referred to in FIG. 3 as the “current IP packet”). Where the IP packet is an IP version 4 (IPv4) packet, the length field is a 16-bit field in the IP packet header that indicates the total size of the IP packet (in other words, the size of the packet header and payload combined). Where the IP packet is an IP version 6 (IPv6) packet, the length field is a 16-bit field in the IP packet header that indicates the size of the payload of the IP packet only. IP filter 310 locates the length field by using a fixed offset between the location of the first bit of the current IP packet and the location of the first bit of the length field, wherein the offset is specified by the relevant IP standard. For the first IP packet in the MPE-FEC frame, the first bit of the current IP packet will be the first bit read out of first memory 306. For subsequent IP packets, the first bit of the IP packet will be determined based on the length field in the previous IP packet header as discussed below.

At decision step 404, IP filter 310 determines whether the length field located in step 402 includes a byte that may contain an error. IP filter 310 performs this step by accessing erasure information associated with each byte of the length field that is stored in second memory 308. In one embodiment of the present invention, IP filter 310 accesses erasure information associated with each byte of the current IP packet as it is drained from first memory 306. In addition to determining whether or not the length field includes a byte that may contain an error, IP filter 306 may additionally use such erasure information to determine whether the current IP packet includes any bytes that may contain an error, whether the header of the current IP packet includes any bytes that may contain an error, or whether certain header fields other than the length field include any bytes that may contain an error. Such additional information may be used by IP filter 310 to determine whether or not to ultimately retain or discard the current IP packet.

If, during decision step 404, IP filter 310 determines that the length field located in step 402 does not include a byte that may contain an error, then IP filter 310 makes a decision to retain or discard the current IP packet as shown at step 412. Although the bytes of the length field contain no errors, IP filter may nevertheless discard the current IP packet, for example, if the current IP packet includes any bytes that may contain an error, if the header of the current IP packet includes any bytes that may contain an error, or if certain header fields other than the length field include any bytes that may contain an error. Whether IP filter 310 retains or discards an IP packet based on such criteria may be controlled, for example, through the use of one or more software-modifiable configuration bits.

After the current IP packet is retained or discarded at step 412, IP filter 310 then accesses a next IP packet within first memory 306 as shown at step 414. IP filter 310 accesses a next IP packet within first memory 306 by using the length field from the current IP packet header to determine the total packet length of the current IP packet. For IPv4, the packet length field may be used directly to provide the total packet length. For IPv6, 40 bytes may be added to the payload length field to provide the total packet length. The location of the next IP packet is then determined by adding the total packet length as an offset to the start location of the current IP packet.

At decision step 416, IP filter 416 determines whether a next IP packet is available within first memory 306. If another IP packet is available within first memory 306, then processing returns to step 402 and the next IP packet is treated as the current IP packet. If another IP packet is not available within first memory 306, then processing ends as indicated at step 418.

Returning now to decision step 404, if IP filter 310 determines that the length field located in step 402 does include a byte that may contain an error, then IP filter 310 determines the total packet length of the current IP packet based on the suspect length field. Various methods by which the length field may be used to determine the total packet length have been described above in reference to step 414. IP filter 310 then parses the MPE-FEC frame stored in first memory to locate a next IP packet based on the determined total packet length, as shown at step 406.

At decision step 408, IP filter 310 determines whether or not the next IP packet located in step 406 appears to be a valid IP packet. In one embodiment, IP filter 310 performs this step by determining whether one or more fields within the packet header of the next IP packet contain certain values. For example, some IP packet header fields have fixed values or acceptable ranges of values as defined by a relevant IP standard. IP filter 310 may locate one or more of these fields within the packet header of the next IP packet and determine if they contain an acceptable value. By way of example, IP filter 310 may determine if a version field within the next IP packet header contains an acceptable value. If the version field within the next IP packet header contains an acceptable value, then IP filter 310 deems the next IP packet valid. If the version field within the next IP packet header does not contain an acceptable value, then IP filter 310 deems the next IP packet invalid. Persons skilled in the relevant art(s) will readily appreciate that numerous other methods may be used to determine whether or not the next IP packet is a valid IP packet.

If, during decision step 408, IP filter 310 determines that the next IP packet located in step 406 does not appear to be a valid IP packet, then IP filter 310 discards the current IP packet and all subsequent IP packets in the MPE-FEC frame as shown at step 410, and then processing ends as shown at step 418. The IP packets are discarded because, due to the outcome of decision step 408, it is assumed that the length field in the current IP packet header is incorrect. If the length field is incorrect, then relying on that field to drain the IP packets from the memory will produce invalid IP packets starting with the current IP packet all the way through to the last IP packet in the MPE-FEC frame.

If, however, during decision step 408, IP filter 310 determines that the next IP packet located in step 406 appears to be a valid IP packet, then processing proceeds to step 412. As described above, during step 412, IP filter 310 makes a decision to retain or discard the current IP packet based on one or more factors that may include, but are not limited to, whether the current IP packet includes any bytes that may contain an error, whether the header of the current IP packet includes any bytes that may contain an error, or whether certain header fields include any bytes that may contain an error.

After the current IP packet is retained or discarded at step 412, IP filter 310 then accesses a next IP packet within first memory 306 as shown at step 414 by using a determined total packet length for the current IP packet as previously described. At decision step 416, IP filter 416 determines whether a next IP packet is available within first memory 306. If another IP packet is available within first memory 306, then processing returns to step 402 and the next IP packet is treated as the current IP packet. If another IP packet is not available within first memory 306, then processing ends as indicated at step 418.

In alternative implementations of the foregoing method, the test performed at step 406 and all subsequent processing stemming therefrom may be performed for IP packets other than only those that have suspect length fields. For example, in one embodiment, the test and all subsequent processing is performed for any IP packet that includes a byte that may contain an error after the performance of RS decoding. In a still further embodiment, the test and all subsequent processing is performed for all IP packets regardless of whether they include a byte that may contain an error after the performance of RS decoding.

### C. MPE-FEC DECODER IN ACCORDANCE WITH A SECOND EMBODIMENT OF THE PRESENT INVENTION

The foregoing approach to MPE-FEC decoding described in Section B provides a method for preserving good IP packets in an MPE-FEC frame even when certain packets within the frame include one or more bytes that may contain an error after the performance of RS decoding. However, in accordance with the approach of Section B, where the length field in an IP packet header appears to include an erroneous byte after RS decoding (based both on erasure information associated with the byte and on parsing of the MPE-FEC frame as described above), the IP packet and all subsequent IP packets in the MPE-FEC frame still must be discarded.

In this Section, an alternate approach to MPE-FEC decoding will be described that allows good IP packets in an MPE-FEC frame to be preserved even where one of the preceding IP packets in the MPE-FEC frame includes a length field that is truly in error. This feature provides an advantage over the approach described in Section B. However, as will be made evident by the description provided below, this advantage comes at the expense of additional memory and associated control logic in the design of the MPE-FEC decoder. Furthermore, as will be described below, the approach described in this Section is more susceptible to the loss of IP packets if one or more sections corresponding to an MPE-FEC frame are dropped prior to MPE-FEC decoding.

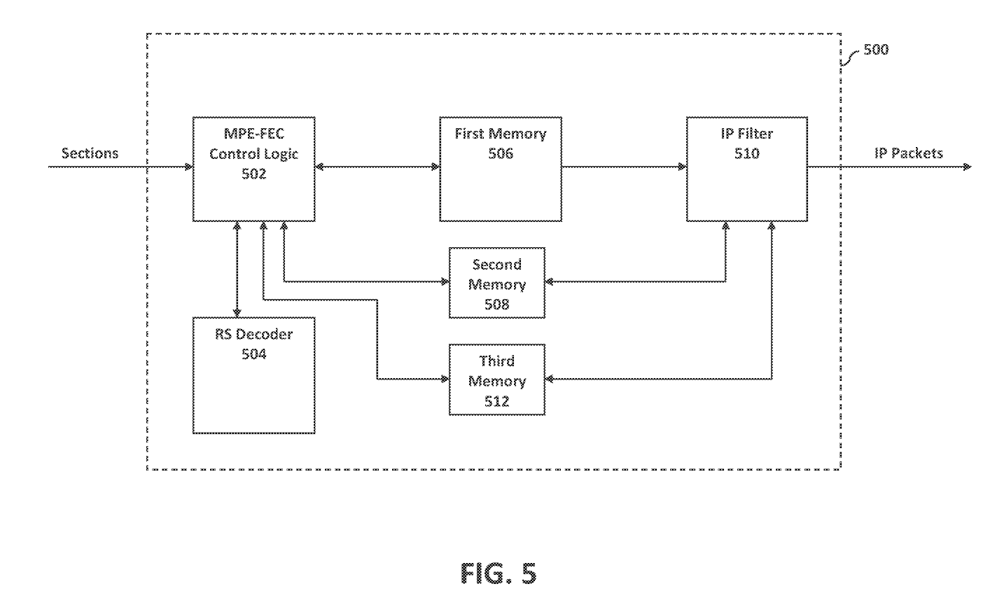

FIG. 5 is a block diagram of an MPE-FEC decoder 500 in accordance with this alternate embodiment of the present invention. Like MPE-FEC decoder 300 of FIG. 3, MPE-FEC decoder 500 may be used, for example, to implement all or part of MPE-FEC logic 208 of example DVB-H receiver 200 described above in reference to FIG. 2, although this example is not intended to limit the present invention.

Like MPE-FEC decoder 300 of FIG. 3, MPE-FEC decoder 500 is implemented in hardware, although operating parameters associated with the functions of MPE-FEC decoder 500 may be configurable via software. As shown in FIG. 5, MPE-FEC decoder 500 includes MPE-FEC control logic 502, an RS decoder 504, a first memory 506, a second memory 508, a third memory 512, and an IP filter 510.

In a like manner to similarly-named elements of MPE-FEC decoder 300, MPE-FEC control logic 502 is configured to load first memory 506 with IP packets and associated parity data, to load second memory 508 with erasure information, and to use RS decoder 504 to perform error correction operations on the data stored in first memory 506 using the erasure information stored in second memory 508. However, in contrast to MPE-FEC logic 302 of MPE-FEC decoder 300, MPE-FEC control logic 502 is further configured to store information indicating where each IP packet will be stored in first memory 506 prior to or while loading the IP packet into first memory 506. MPE-FEC control logic 502 is configured to store this information in a third memory 512. Third memory 512 may be implemented, for example, using any of a variety of well-known semiconductor memory types. For example, third memory 512 may be implemented using an SRAM.

IP filter 510 is configured in a like manner to IP filter 310 of MPE-FEC decoder 300 to drain IP packets from first memory 506 after RS decoding has completed. However, unlike IP filter 310, IP filter 510 does not rely on a length field in the header of each IP packet to determine where the IP packet ends and a subsequent packet begins. Rather, IP filter 510 uses the information stored in third memory 512 to determine where each IP packet stored in first memory 506 begins and ends. IP filter 510 can then use the erasure information stored in second memory to determine whether or not to retain or discard a particular IP packet based on the presence of one or more bytes that may be in error even after RS decoding.

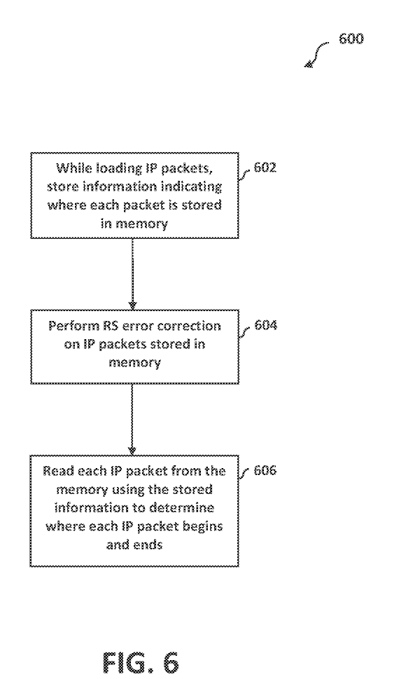

The manner in which MPE-FEC logic 502 operates to write IP packets into first memory 506 and IP filter 510 operates to read IP packets out of first memory 506 will now be described in more detail in reference to flowchart 600 of FIG. 6. The method of flowchart 600 will be described with continued reference to the components of MPE-FEC decoder 500 as described above in reference to FIG. 5. However, the method is not limited to that embodiment and persons skilled in the relevant art(s) will readily appreciate that the method of flowchart 600 may be performed by using other components or systems.

As shown in FIG. 6, the method of flowchart 600 begins at step 602, in which MPE-FEC logic 502 stores information indicating where each IP packet in an MPE-FEC frame will be stored in first memory 506 prior to or while loading the IP packets into first memory 506. The information is stored in third memory 512.

The stored information may include, for example, a physical address at which a first byte (or other discrete portion) of an IP packet is stored in first memory 506. Alternatively, this information may include a physical address at which a last byte (or other discrete portion) of an IP packet is stored in first memory 506. This information may alternatively include an indicator associated with each byte stored in first memory 506, the indicator indicating whether the byte is the first or last byte of an IP packet. However, these information types are provided by way of example only, and other information may be used to indicate where each IP packet is stored in first memory 506. In an approach that stores a physical address associated with each IP packet, third memory 512 must be large enough to store addresses associated with the maximum number of IP packets that may be encapsulated within a single MPE-FEC frame.

At step 604, MPE-FEC logic 502 reads out information from first memory 506 for processing by RS decoder 504. RS decoder 504 performs error correction operations on the IP packets stored in first memory 506 in a manner previously described with reference to MPE-FEC decoder 300 of FIG. 3.

At step 606, IP filter 510 reads each IP packet from first memory 506 using the information stored in memory 512 to determine where each IP packet begins and ends. During this process, IP filter 510 may use the erasure information stored in second memory 508 to determine whether or not to retain or discard a particular IP packet based on the presence of one or more bytes that may be in error even after RS decoding. Whether IP filter 310 retains or discards a particular IP packet based on the presence of one or more bytes that may be in error even after RS decoding may be controlled, for example, through the use of one or more software-modifiable configuration bits.

The foregoing approach to MPE-FEC decoding allows good IP packets in an MPE-FEC frame to be preserved even where one of the preceding IP packets in the MPE-FEC frame includes a length field that is truly in error. However, this advantage comes at the expense of adding third memory 512 and associated control logic for writing and reading the information stored therein.

Furthermore, the foregoing approach is susceptible to the loss of IP packets if one or more sections corresponding to an MPE-FEC frame are dropped prior to MPE-FEC decoding. In this instance, MPE-FEC control logic 510 would be incapable of storing location information in third memory 512 indicating where IP packets associated with the dropped sections have been stored within first memory 506. Thus, IP filter 510 will be incapable of draining such IP packets from first memory 506, even if such packets could be restored through RS decoding. In contrast, the approach described above in Section B might be able to save such IP packets by using information within the IP packets themselves to determine where such IP packets begin and end.

### D. IMPLEMENTATIONS IN ACCORDANCE WITH ALTERNATIVE EMBODIMENTS OF THE PRESENT INVENTION

An alternative implementation of the present invention combines the approaches of Section A and Section B as described above to provide a particularly robust method for preserving good IP packets in an MPE-FEC frame even when certain packets within the frame include one or more bytes that may contain an error after the performance of RS decoding. Such an implementation uses a combination of stored erasure information, length information from within the IP packets themselves, and stored information indicating where each IP packet is stored in memory to read IP packets from memory after the completion of RS decoding.

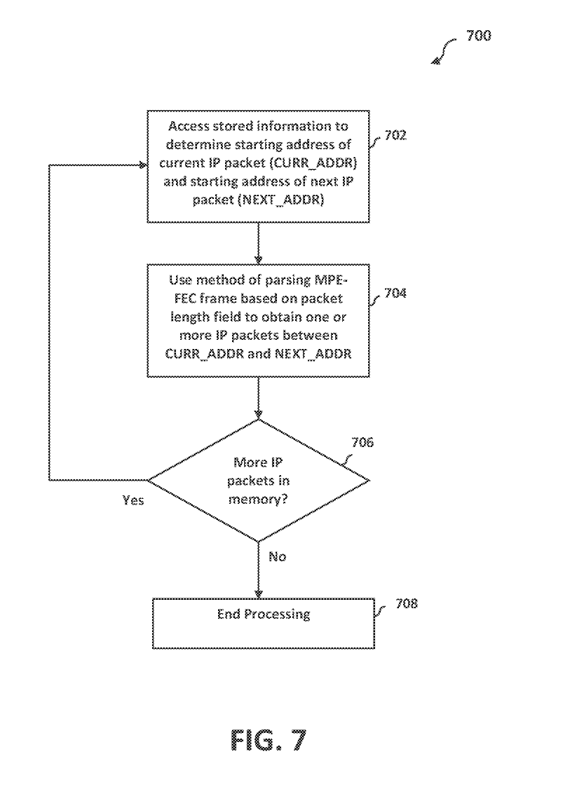

FIG. 7 depicts a flowchart 700 of one such combined approach. It is assumed that prior to the application of the method of flowchart 700, information has been stored that indicates the starting address at which each IP packet in an MPE-FEC frame was written in a first memory. This information may be stored prior to or while loading the IP packets into the first memory, in a like manner to the embodiment described above in reference to FIGS. 5 and 6.

At step 702, the stored information is accessed to determine the starting address of the current IP packet to be read from the first memory (denoted “CURR_ADDR”) and the starting address of the next IP packet to be read from the first memory (denoted “NEXT_ADDR”).

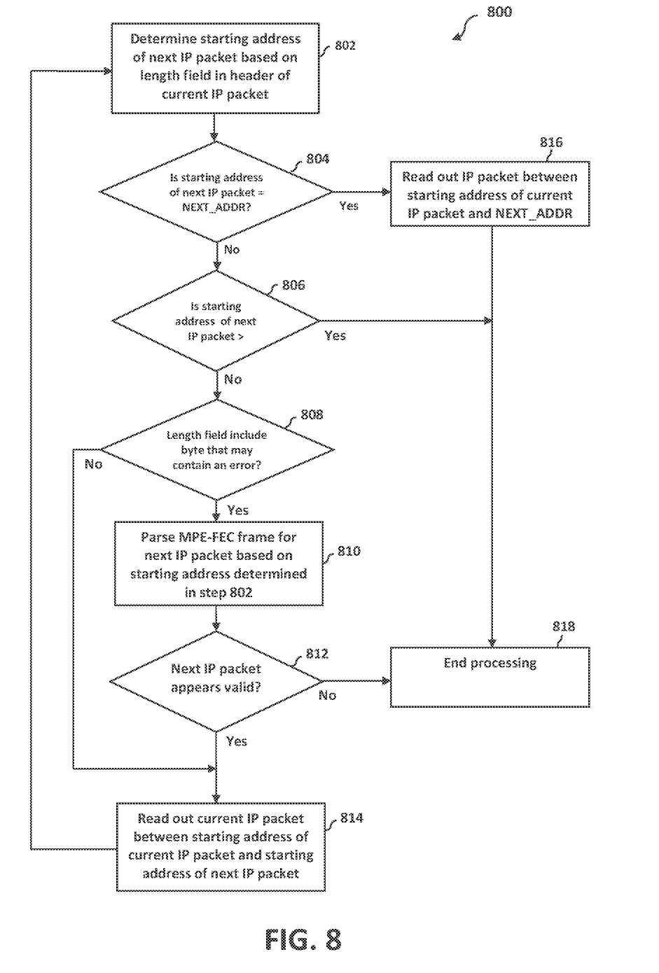

At step 704, CURR_ADDR and NEXT_ADDR are provided to logic that parses the MPE-FEC frame based on a packet length field to obtain one or more IP packets between CURR_ADDR and NEXT_ADDR. The parsing method may be similar to that described above in reference to the embodiments of FIGS. 3 and 4. Normally, one would expect to find only a single IP packet between CURR_ADDR and NEXT_ADDR. However, if one or more sections corresponding to the MPE-FEC frame were dropped prior to MPE-FEC decoding, there may be more than one IP packet in the gap between CURR_ADDR and NEXT_ADDR. A particular method for performing this step will be described below in reference to FIG. 8.

During this process, erasure information associated with each obtained IP packet may be used to determine whether or not to retain or discard a particular IP packet based on the presence of one or more bytes that may be in error even after RS decoding. Whether a particular IP packet is retained or discarded a particular IP packet based on the presence of one or more bytes that may be in error even after RS decoding may be controlled, for example, through the use of one or more software-modifiable configuration bits

At decision step 706, it is determined whether there are more IP packets in the first memory that need to be read. If there are, then processing returns to step 702 and the next IP packet is treated as the current IP packet. If there are no more IP packets in the first memory that need to be read, then processing ends as shown at step 708.

FIG. 8 depicts a flowchart 800 of one method for performing step 704 of flowchart 700. The method begins at step 802, in which the starting address of the next IP packet in the first memory is determined based on the length field in the header of the current IP packet.

At decision step 804, the starting address for the next IP packet determined in step 802 is compared to NEXT_ADDR. If the addresses are the same, then the IP packet between the starting address of the current IP packet and NEXT_ADDR is read out as shown at step 816, and then processing ends as shown at step 818.

If, however, the starting address for the next IP packet determined in step 802 is not the same as NEXT_ADDR, then processing proceeds to decision step 806. At decision step 806, it is determined whether the starting address for the next IP packet determined in step 802 exceeds NEXT_ADDR. If the starting address for the next IP packet determined in step 802 does exceed NEXT_ADDR, then it is assumed that the starting address for the next IP packet determined in step 802 is in error, and processing ends as shown at step 818.

If, however, the starting address for the next IP packet determined in step 802 does not exceed NEXT_ADDR, then processing proceeds to decision step 808. In this case, the starting address for the next IP packet determined in step 802 lies somewhere between START_ADDR and NEXT_ADDR, so there is a possibility that there is more than one IP packet between START_ADDR and NEXT_ADDR.

At decision step 808, it is determined whether the length field used in step 802 includes a byte that may contain an error. This step may include accessing erasure information associated with each byte of the length field. If it is determined that the length field does not include a byte that may contain an error, then the IP packet between the starting address of the current IP packet and the starting address of the next IP packet determined in step 802 is read out as shown at step 814. Processing then returns to step 802 to obtain additional IP packets, if there are any, between START_ADDR and NEXT_ADDR.

If however, it is determined at decision step 808 that the length field used in step 802 includes a byte that may contain an error, then the MPE-FEC frame stored in the first memory is parsed to locate the next IP packet using the starting address determined in step 802, as shown at step 810. At decision step 812, it is determined whether the next IP packet located in step 810 appears to be a valid IP packet. If the next IP packet located in step 810 does not appear to be a valid IP packet, then processing ends as shown at step 818. If, however, the next IP packet located in step 810 does appear to be a valid IP packet, then the IP packet between the starting address of the current IP packet and the starting address of the next IP packet determined in step 802 is read out as shown at step 814. Processing then returns to step 802 to obtain additional IP packets, if there are any, between START_ADDR and NEXT_ADDR.

The methods of flowcharts 700 and 800 have been provided herein by way of example only. Persons skilled in the relevant art(s) will readily appreciate that other methods may be used that combine the approaches of Section A and Section B as described above to preserve good IP packets in an MPE-FEC frame even when certain packets within the frame include one or more bytes that may contain an error after the performance of RS decoding

### E. CONCLUSION

References in the foregoing to “one embodiment,” “an embodiment,” “an example embodiment,” and the like, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of persons skilled in the relevant art(s) to effect such feature, structure, or characteristic in connection with other embodiments whether or not explicitly described.

While various embodiments of the present invention have been described above, it should be understood that they have been presented by way of example only, and not limitation. It will be understood by persons skilled in the relevant art(s) that various changes in form and details may be made to the embodiments of the present invention described herein without departing from the spirit and scope of the invention as defined in the appended claims. Accordingly, the breadth and scope of the present invention should not be limited by any of the above-described exemplary embodiments, but should be defined only in accordance with the following claims and their equivalents.

What is claimed is:

1. A method for recovering Internet Protocol (IP) packets from a Multiprotocol Encapsulation-Forward Error Correction (MPE-FEC) frame stored in a memory after the performance of MPE-FEC operations, wherein the MPE-FEC frame includes a series of IP packets, comprising:
(a) determining the length of a first IP packet stored in the memory based on information stored in the first IP packet;
(b) parsing the MPE-FEC frame to locate a second IP packet based on the length determined in step (a);
(c) determining if the second IP packet is a valid IP packet; and
(d) responsive to determining that the second IP packet is a valid IP packet, retaining at least one of the first IP packet or an IP packet following the first IP packet in the series of IP packets regardless of whether the first IP packet includes a byte that may contain an error after the performance of the MPE-FEC operations.

2. The method of claim 1, further comprising:
(e) discarding the first IP packet and any IP packets following the first IP packet in the series of IP packets responsive to determining that the second IP packet is not a valid IP packet.

3. The method of claim 1, further comprising:
determining if the first IP packet includes a byte that may contain an error after performing MPE-FEC operations; and
performing steps (a) through (d) responsive to determining that the first IP packet includes a byte that may contain an error after performing MPE-FEC operations.

4. The method of claim 3, wherein determining if the first IP packet includes a byte that may contain an error after performing MPE-FEC operations comprises:
determining if a length field within a header of the first IP packet includes a byte that may contain an error after performing MPE-FEC operations.

5. The method of claim 1, wherein step (c) comprises:
determining if a field within a header of the second IP packet contains an acceptable value.

6. The method of claim 1, wherein step (d) comprises:
discarding the first IP packet responsive to determining that the first IP packet includes at least one byte that may contain an error after the performance of the MPE-FEC operations but retaining at least one IP packet following the first IP packet in the series of IP packets.

7. The method of claim 6, wherein discarding the first IP packet responsive to determining that the first IP packet includes at least one byte that may contain an error after the performance of the MPE-FEC operations comprises:
checking a configuration bit to determine if the first IP packet should be discarded.

8. A system for recovering Internet Protocol (IP) packets from a Multiprotocol Encapsulation-Forward Error Correction (MPE-FEC) frame after the performance of MPE-FEC operations, wherein the MPE-FEC frame includes a series of IP packets, comprising:
a memory configured to store the series of IP packets; and
an IP filter configured to determine the length of a first IP packet stored in the memory based on information stored in the first IP packet, to parse the MPE-FEC frame to locate a second IP packet based on the determined length, to determine if the second IP packet is a valid IP packet, and to retain at least one of the first IP packet or an IP packet following the first IP packet in the series of IP packets regardless of whether the first IP packet includes a byte that may contain an error after the performance of the MPE-FEC operations responsive to determining that the second IP packet is a valid IP packet.

9. The system of claim 8, wherein the IP filter is further configured to discard the first IP packet and any IP packets following the first IP packet in the series of IP packets responsive to determining that the second IP packet is not a valid IP packet.

10. The system of claim 8, wherein the IP filter is further configured to determine if the first IP packet includes a byte that may contain an error after the performance of the MPE-FEC operations, and to parse the MPE-FEC frame to locate a second IP packet based on the determined length responsive to determining that the first IP packet includes a byte that may contain an error after the performance of the MPE-FEC operations.

11. The system of claim 10, wherein the IP filter is configured to determine if the first IP packet includes a byte that may contain an error after the performance of the MPE-FEC operations by determining if a length field within a header of the first IP packet includes a byte that may contain an error after the performance of the MPE-FEC operations.

12. The system of claim 8, where the IP filter is configured to determine if the second IP packet is a valid IP packet by determining if a field within the header of the second IP packet contains an acceptable value.

13. The system of claim 8, wherein the IP filter is configured to discard the first IP packet responsive to determining that the first IP packet includes at least one byte that may contain an error after the performance of the MPE-FEC operations but to retain at least one IP packet following the first IP packet in the series of IP packets responsive to determining that the second IP packet is a valid IP packet.

14. The system of claim 13, wherein the IP filter is configured to check a configuration bit to determine if the first IP packet should be discarded.

15. A method for recovering Internet Protocol (IP) packets from a Multiprotocol Encapsulation-Forward Error Correction (MPE-FEC) frame stored in a memory after the performance of MPE-FEC operations, wherein the MPE-FEC frame includes a series of IP packets, comprising:
storing information indicating where each IP packet in the series of IP packets is stored in the memory;
performing MPE-FEC operations on the series of IP packets stored in the memory;
reading each IP packet in the series of IP packets from the memory using the stored information to determine where each IP packet begins and ends; and
retaining at least one IP packet in the series of IP packets for further processing regardless of whether another IP packet in the series of IP packets includes a byte that may contain an error after the performance of the MPE-FEC operations.

16. The method of claim 15, wherein storing information indicating where each IP packet in the series of IP packets is stored in a memory comprises storing a memory address associated with each IP packet.

17. The method of claim 15, further comprising:
discarding one or more IP packets in the series of IP packets that include a byte that may contain an error after the performance of the MPE-FEC operations.

18. The method of claim 17, wherein discarding one or more IP packets in the series of IP packets that includes a byte that may contain an error after the performance of the MPE-FEC operations comprises:
checking a configuration bit to determine if the one or more IP packets should be discarded.

19. A system for recovering Internet Protocol (IP) packets from a Multiprotocol Encapsulation-Forward Error Correction (MPE-FEC) frame after the performance of MPE-FEC operations, wherein the MPE-FEC frame includes a series of IP packets, comprising:
a memory configured to store the series of IP packets;
control logic coupled to the memory and configured to store information indicating where each IP packet in the series of IP packets is stored in the memory;
error correction logic configured to perform MPE-FEC operations on the series of IP packets stored in the memory; and
an IP filter coupled to the memory and configured to read each IP packet in the series of IP packets from the memory using the stored information to determine where each IP packet begins and ends and to retain at least one IP packet in the series of IP packets for further processing regardless of whether another IP packet in the series of IP packets includes a byte that may contain an error after the performance of the MPE-FEC operations.

20. The system of claim 19, wherein the control logic is configured to store information indicating where each IP packet in the series of IP packets is stored in the memory by storing a memory address associated with each IP packet.

21. The system of claim 19, wherein the IP filter is further configured to discard one or more IP packets in the series of IP packets that include a byte that may contain an error after the performance of the MPE-FEC operations.

22. The system of claim 21, wherein the IP filter is configured to check a configuration bit to determine if the one or more IP packets should be discarded.

23. A method for recovering Internet Protocol (IP) packets from a Multiprotocol Encapsulation-Forward Error Correction (MPE-FEC) frame stored in a memory after the performance of MPE-FEC operations, wherein the MPE-FEC frame includes a series of IP packets, comprising:
accessing stored information to determine a first location at which a first IP packet in the series of IP packets is stored in the memory and a second location at which a second IP packet in the series of IP packets is stored in the memory; and
reading one or more IP packets in the series of IP packets between the first location and the second location, wherein reading the one or more IP packets comprises determining a length of each of the one or more IP packets based on a length field in a header of the IP packet.

24. The method of claim 23, wherein reading the one or more IP packets further comprises validating the length field in the header of each of the one or more IP packets.

25. The method of claim 24, wherein validating the length field in the header of each of the one or more IP packets comprises:
locating a subsequent IP packet in the series of IP packets within the memory based on the length field; and
determining whether the subsequent IP packet is a valid IP packet.
